(19) United States
(12) Patent Application Publication
(10) Pub. No.: US 2013/0226648 A1
(43) Pub. Date: Aug. 29, 2013

(54) METHOD AND DEVICE FOR OPTIMISING A PRODUCTION PROCESS

(71) Applicant: ABB AG, (US)

(72) Inventors: Alexander HORCH, Heidelberg (DE); Guido SAND, Weinheim (DE); liro HARJUNKOSKI, Weinheim (DE); Sleman SALIBA, Heidelberg (DE)

(73) Assignee: ABB AG, Mannheim (DE)

(21) Appl. No.: 13/862,785

(22) Filed: Apr. 15, 2013

Related U.S. Application Data
(63) Continuation of application No. PCT/EP2011/004954, filed on Oct. 5, 2011.

(30) Foreign Application Priority Data
Oct. 15, 2010 (DE) 10 2010 048 409.1

(51) Int. Cl. G06Q 10/06

(52) U.S. Cl. CPC G06Q 10/06315
USPC 705/7.22

(57) ABSTRACT

A method and an apparatus are disclosed for operating a production plant in a production process in the manufacturing industry or the process industry by optimizing the operation of the production process, in which the efficient use of the available energy is taken into account as a further optimization variable.

### RELATED APPLICATION(S)

This application claims priority as a continuation application under 35 U.S.C. §120 to PCT/EP2011/004954, which was filed as an International Application on Oct. 5, 2011, designating the U.S., and which claims priority to European Application No. 102010048409.1 filed on Oct. 15, 2010. The entire contents of these applications are hereby incorporated by reference in their entireties.

### FIELD

The present disclosure generally relates to methods for optimizing production processes in the manufacturing industry or the process industry. The present disclosure also relates to measures for operating a production plant in an energy-efficient manner, such as for planning, regulating and controlling production in such a manner that the energy and raw materials involved are each optimized.

### BACKGROUND INFORMATION

In previous methods for planning and carrying out production, an attempt is made to optimize production with respect to one or more process variables. This is effected taking into account different boundary conditions, for example order deadlines, machine restrictions, maintenance standstills and the like. Mathematical optimization methods which yield optimum solutions for predefined cost functions, the designations cost function or objective function or else energy function being customary synonyms, and boundary conditions are used in many cases for the purpose of optimization.

An attempt is also made to include the energy consumption, like previously the use of raw materials, as a boundary condition in these optimization methods. It is very difficult to solve such multi-criteria optimization problems, which is why the consideration of the energy consumption has not yet been successful in industrial applications. Known optimization methods still clearly focus on maximizing production with a given budget, for example the use of materials and raw materials, taking into account production boundary conditions, for example the number of machines or formula specifications.

At the same time, as a result of the liberalization of the power market and energy exchange trading, it is increasingly possible to flexibly purchase power or energy on stock markets. In this case, purchase quantities and the purchase period as well as a corresponding price are defined. In the case of production plants which themselves also produce energy, energy is not only purchased on the stock markets but is also, conversely, fed into the supply system.

An existing production plan which is the basis for the amount of energy to be procured can be used to determine an amount of energy desired. This amount of energy can then be purchased as favorably as possible on the energy stock markets.

With the increasing spread of alternative energy sources and in view of the conversion of the known power supply systems into so-called smart grids, power trading for production companies is increasingly taking place in real time. This means that the power prices vary to a greater extent and the system operators look for possibilities for favorably selling excess power, while they raise the prices when the amount of energy runs short, for example in bad weather or when there is no wind. Although it will be possible in the future to purchase power at up-to-the-minute prices, provision has hitherto not been made for the energy consumption to be taken into account in the planning of production processes. If this were the case, it would be possible to make the total energy purchase more uniform for a system operator and to adapt it, for example, to the current availability of energy.

For example, a system operator having an excess supply of energy, as may occur, for example, on account of strong wind at the location of a wind power station, cannot efficiently store the energy. The system operator will therefore attempt to sell this energy to a production company by means of a variable price. The production company could then attempt to adapt its production planning or implementation in such a manner that preference is given to energy-consuming processes and, under certain circumstances, overproduction is allowed, the intermediate products or subproducts of which can be produced inexpensively on account of the available energy. Excess energy in the power supply system could thus be temporarily stored in the production company virtually as a subproduct, an intermediate product or an end product. However, in order to use this possibility, the production company should be able to replan its production in a rapid and flexible manner according to the changes in the availability of energy and to decide whether it is sensible to change production implementation given the changed availability of energy.

Conversely, in the event of a significant drop in the energy supply, for example as a result of a lack of wind or reduced solar radiation for solar systems, the system operator can benefit from consumers who are prepared to reduce the amount of energy desired even if this energy has been reserved or purchased. In this case too, the production company could check the extent to which production implementation could be replanned in order to thus meet the system operator's request. In particular when production is not being utilized fully, degrees of freedom may arise here which make it possible to shift energy-consuming production processes into the future.

On account of weather forecasts, the system operator is also provided with information relating to the availability of energy in the near future. The production company can therefore be provided not only with the details of the current availability of energy but also with predicted trends for the future availability of energy. Taking into account the availability of energy as a further optimization variable would add a further optimization variable, namely energy efficiency, to the already existing optimization system, that is to say production with regard to throughput, for example, which relates to the production volume, and/or with regard to plant health, for example, which relates to gentle operation of the production plant. The optimization methods could thus become extremely complex and computation-intensive, with the result that the methods may not be usable when the availability of energy changes quickly.

### SUMMARY

A method is disclosed for energy-efficient operation of a production plant in a production process of a manufacturing industry or a process industry, by causing a data processing unit to execute functions of: creating and optimizing a first production schedule (PAP1) according to a predefined first cost function (KF1) and a predefined production process model (M), the first cost function (KF1) being designed to determine a first cost variable (K1) and taking into account efficient use of available energy as an optimization goal; creating and optimizing one or more second production schedules (PAP2, PAP3) in parallel to the creating and optimizing of the first production schedule (PAP1) and according to a respective predefined second cost function (KF2, KF3) and the predefined production process model (M), the one or more second cost functions (KF2, KF3) being designed to determine one or more second cost variables (K2, K3) and taking into account as optimization goals one or more of the following production goals: production volume, plant protection, production safety or duration of maintenance intervals; assessing the first (PAP1) and the one or more second (PAP2, PAP3) production schedules with the aid of the cost functions (KF2, KF3; KF1) with respect to other optimization goals, such that corresponding cost variables (K1(PAP1), K2(PAP1), K3(PAP1), K1(PAP2), K2(PAP2), K3(PAP2), K1(PAP3), K2(PAP3), K3(PAP3)) which indicate how the individual optimization goals have been achieved, are provided overall for each production schedule (PAP1, PAP2, PAP3); weighing the cost variables (K1, K2, K3) respectively associated with one of the production schedules (PAP1, PAP2, PAP3) with weighting variables (G1, G2, G3); determining a total cost variable (KG) as a sum of the weighted cost variables for each of the production schedules (PAP1, PAP2, PAP3); determining that production schedule whose total cost variable is lowest as an optimum production schedule (PAPₒₚₜ); and implementing the optimum production schedule in the production process for regulating and controlling production of the production plant.

An apparatus is disclosed for energy-efficient operation of a production plant in a production process of a manufacturing industry or a process industry, wherein data processing unit has an optimization system for determining an optimum production schedule (PAPₒₚₜ), the optimization system comprising: a first optimizer for creating and optimizing a first production schedule (PAP1) according to a first cost function (KF1) and a predefined production process model (M), the first cost function (KF1) being designed to determine a first cost variable (K1) and taking into account efficient use of the available energy as an optimization goal; a second optimizer for creating and optimizing one or more second production schedules in parallel with the creating and optimizing of the first production schedule (PAP1) and according to respective one or more second cost functions (KF2, KF3) and the predefined production process model (M), the one or more second cost functions (KF2, KF3) being designed to determine one or more second cost variables (K2, K3) and taking into account as other optimization goals one or more of the following production goals: production volume, plant protection, production safety or duration of maintenance intervals; a respective assessment block for assessing the first (PAP1) and the one or more second (PAP2, PAP3) production schedules with aid of the cost functions (KF2, KF3; KF1) with respect to the other optimization goals, such that corresponding cost variables (K1(PAP1), K2(PAP1), K3(PAP1), K1(PAP2), K2(PAP2), K3(PAP2), K1(PAP3), K2(PAP3), K3(PAP3)) which indicate how the individual optimization goals have been achieved, are provided overall for each production schedule (PAP1, PAP2, PAP3); a respective weighting block for weighing the cost variables (K1, K2, K3) respectively associated with one of the production schedules (PAP1, PAP2, PAP3) with weighting variables (G1, G2, G3); a comparison block for determining a total cost variable (KG) as a sum of the weighted cost variables for each of the production schedules (PAP1, PAP2, PAP3), and for determining a production schedule whose total cost variable is lowest as an optimum production schedule (PAPₒₚₜ) to be implemented in the production process for regulating and controlling production of the production plant.

### BRIEF DESCRIPTION OF THE DRAWINGS

Exemplary embodiments will be explained in more detail below with reference to the accompanying drawings, in which:

FIG. 1 shows a schematic block diagram of an exemplary optimization system for optimizing a production process; and

FIG. 2 shows a functional diagram for illustrating an exemplary iterative determination of a production schedule.

### DETAILED DESCRIPTION

A method and an apparatus are disclosed for operating a production plant in a production process in the manufacturing industry or the process industry by optimizing the operation of the production process, in which the efficient use of the available energy is taken into account as a further optimization variable.

A first aspect provides a method for operating a production plant in an energy-efficient manner in a production process in the manufacturing industry or the process industry. The method can include creating and optimizing a first production schedule according to a predefined first cost function and a predefined production process model, the first cost function being designed to determine a first cost variable and taking into account the efficient use of the available energy as an optimization goal; creating and optimizing one or more second production schedules in parallel to the creating and optimizing of the first production schedule and according to a respective predefined second cost function and the predefined production process model, the one or more second cost functions being designed to determine one or more second cost variables and taking into account as optimization goals one or more of the following production goals: production volume, plant protection, production safety or duration of maintenance intervals; assessing the first (PAP1) and the one or more second (PAP2, PAP3) production schedules with the aid of the respective other cost functions with respect to the respective other optimization goals, with the result that the corresponding cost variables which indicate how the individual optimization goals have been achieved, are provided overall for each production schedule; weighing the cost variables respectively associated with one of the production schedules with weighting variables; determining a total cost variable as a sum of the weightes cost variables for each of the production schedules; determining that production schedule whose total cost variable is lowest as the optimum production schedule; and implementing the optimum production schedule in the production process for regulating and controlling the production in the production plant.

An aspect of the present disclosure is to define the efficient use of the available energy as a separate optimization goal and to consider both aspects of an optimum use of the available energy and of the required production as a whole. Coordinating a plurality of optimization goals, which are each assigned a cost function, makes it possible to take the optimization goal of the efficient use of the available energy into account in an equivalent manner or with a particular weighting with respect to other optimization goals. The optimization processes with respect to these optimization goals are coordinated with one another instead of considering an optimization problem which simultaneously takes into account energy use and a further optimization goal, for example throughput. In this case, the method for coordinated optimization has the advantage that existing solutions can be integrated and need not be replaced. The optimization systems can be coordinated by means of a suitable coordinator or by means of a suitable coordination function. This coordinator solves the two equivalent optimization models in a substantially parallel manner and uses the cost functions to assess the two optimization results with respect to an overall optimization goal which takes into account the optimization goals of the plurality of cost functions.

Furthermore, the one or more cost functions may be assigned to one or more of the following exemplary production goals:
throughput,
use of ecologically produced energy, and
use of raw materials.

Provision may be made for the total cost variables to be determined on the basis of predefined weighting variables, for example, as a sum of the weighted cost variables.

An exemplary method can be iteratively carried out by creating the first production schedule and the one or more second production schedules with at least one changed process parameter and/or at least one changed process boundary condition. In this manner, the coordination function can adapt the predefined process parameters and/or boundary conditions and can create production schedules again which are optimized with respect to the plurality of optimization goals.

Furthermore, the method can be iteratively carried out until an abort criterion is present. For example, the abort criterion can correspond to the reaching of a maximum number of repetitions of the process of determining the optimum production schedule or the reaching of a predefined overall optimization criterion.

The change in the process parameter and the process boundary condition can be determined on the basis of the previously determined optimum production schedule.

The change in the process parameter can relate to a number of parallel identical production processes or a power level of a production process which indicates the power with which the production process is operated.

According to an exemplary embodiment, the change in the process boundary condition can relate to a specification of the maximum and/or minimum storage quantities of intermediate products and end products.

Another aspect of the present disclosure provides an apparatus for operating a production plant in an energy-efficient manner in a production process in the manufacturing industry or the process industry with a data processing unit comprising an optimization system for determining an optimum production schedule for implementation or use in a production process, the optimization system comprising:
a first optimizer for creating and optimizing a first production schedule according to a first cost function and a predefined production process model, the first cost function being designed to determine a first cost variable and taking into account the efficient use of the available energy as an optimization goal;
a second optimizer for creating and optimizing one or more second production schedules in parallel with the creating and optimizing of the first production schedule and according to a respective second cost function and the predefined production process model, the one or more second cost functions being designed to determine one or more second cost variables and taking into account as optimization goals one or more of the following production goals: production volume, plant protection, production safety or duration of maintenance intervals;
a respective assessment block for assessing the first and the one or more second production schedules with the aid of the respective other cost functions with respect to the respective other optimization goals, with the result that the corresponding cost variables which indicate how the individual optimization goals have been achieved, are provided overall for each production schedule;
a respective weighting block for weighing the cost variables respectively associated with one of the production schedules with weighting variables; and
a comparison block for determining a total cost variable as a sum of the weightes cost variables for each of the production schedules and for determining that production schedule whose total cost variable is lowest as the optimum production schedule to be implemented in the production process for regulating and controlling the production in the production plant.

Another aspect of the present disclosure provides a computer program product containing a program code which, when executed on a data processing unit, carries out a method as disclosed herein.

Various aspects should be taken into account when optimizing production processes of a production plant belonging to a production company. On the one hand, the energy for operating the production plant is to be procured. This is effected, for example, by purchasing energy from an energy supplier, by internally producing energy, for example by means of in-house or company-owned solar cells, wind turbines and/or miniature power stations, or by recycling energy produced by production-related exothermic processes, such as by obtaining electrical energy from thermal energy which arises.

On the other hand, the production plant consumes energy, the individual production processes each having their own energy consumption. In times of high availability of energy, production can thus be increased and, if possible, production for stock beyond the actual specification can be carried out, whereas, in times of low availability of energy, production can be restricted or even excess energy, such as electrical energy, can be fed back into the power supply system. However, optimum use of the available energy and the desired production can be best achieved by considering both aspects as a whole.

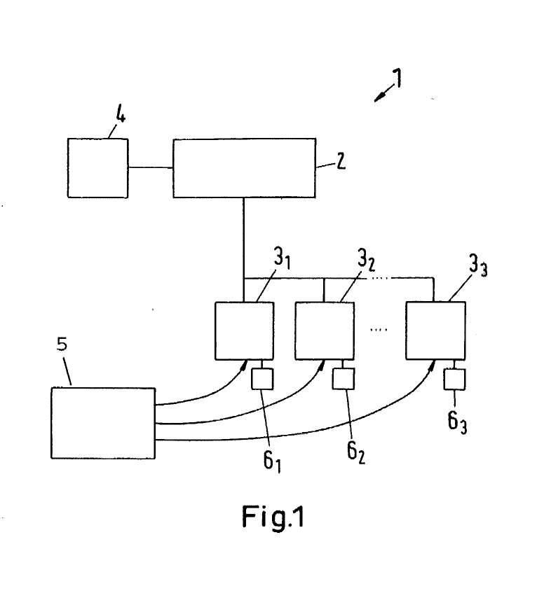

FIG. 1 illustrates a schematic block diagram of an optimization system. The coordinator 2 which is coupled to a plurality of optimizers 3 is situated at the core of the optimization system. In the present example, three optimizers 3₁, 3₂, 3₃ are provided for the optimization goals of throughput, energy use and plant protection. Other optimization aspects (optimization goals) are also possible, for example, the aspect of “green production” in which particular importance is placed on the use of ecologically produced energy. Other optimization aspects could be production safety, that is to say production away from the load and stability limits of the process, and the use of raw materials, that is to say the minimization of the raw materials used.

The weighting of the individual optimization aspects can be predefined to the coordinator 2 by means of a suitable user interface 4. The weighting can be predefined in particular in percentages, with the result that the weighting variables total 100%.

The individual optimizers 3₁, 3₂, 3₃ create or optimize a production schedule PAP according to the respectively assigned optimization goal while taking into account predefined production boundary conditions PR. The production boundary conditions may relate, for example, to order deadlines, machine restrictions, maintenance standstills and the like.

Optimization can be effected on the basis of cost functions KF1, KF2 and KF3 respectively assigned to the optimization goals. The cost functions KF1, KF2, KF3 may therefore take into account, for example, the optimization goals of throughput, production volume, energy efficiency, plant protection and/or duration of the maintenance intervals. The cost functions KF1, KF2, KF3 assign a cost variable K to the production schedule PAP to be considered in a known manner. The cost variable K makes it possible to compare how the individual optimization goals have been achieved. This makes it possible to determine a total cost variable from the individual cost variables with the aid of the weighting variables.

The optimizers 3₁, 3₂, 3₃ are also each provided with a model description M of the underlying model of the production process, which model description can be obtained with the aid of a resource task network 5, for example.

The optimizers 3₁, 3₂, 3₃ are each provided with a corresponding solver 6₁, 6₂, 6₃ which creates a production schedule with respect to the respective cost function KF1, KF2, KF3. The coordinator 2 is provided with the individual production schedules. Each production schedule obtained in this manner is assessed with respect to the other optimization goals in the coordinator 2, that is to say the energy efficiency and plant protection of that production schedule which has been optimized with respect to throughput are assessed with the aid of the respective cost function KF1, KF2, KF3. If, for example, the assessment of the first production schedule with respect to the second optimization goal differs from the energy efficiency of the second production schedule or differs by more than a predetermined tolerance value, an optimization parameter is changed and the optimization processes are carried out again in the individual optimizers 3₁, 3₂, 3₃ with the changed optimization parameters. This implements an iterative optimization process which incorporates existing optimizers and optimization methods.

Alternatively, the individual solutions to the optimization aspects can be combined with the solutions from the other optimizers 3 and a new optimization run with changed boundary conditions can be started, if desired.

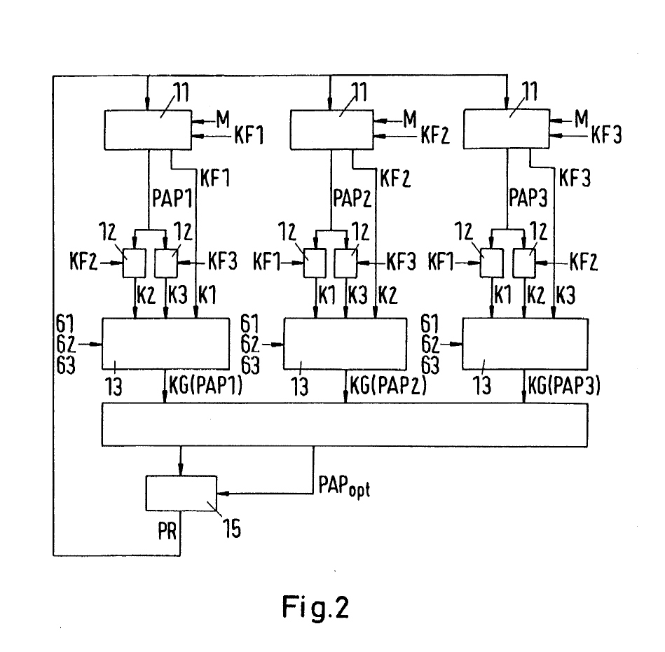

FIG. 2 illustrates an exemplary functional diagram for illustrating an optimization method. In optimization blocks 11, an optimized production schedule PAP1, PAP2, PAP3, which is used to optimize the corresponding cost variable K1, K2, K3 in accordance with the assigned cost function KF1, KF2, KF3, is respectively determined according to the assigned cost functions KF1, KF2, KF3 and the production process module M provided. Each of the production schedules PAP1, PAP2, PAP3 determined in this manner is assessed in a respective assessment block 12 with the aid of the other cost functions KF1, KF2, KF3, with the result that the corresponding cost variables K1(PAP1), K2(PAP1), K3(PAP1), K1(PAP2), K2(PAP2), K3(PAP2), K1(PAP3), K2(PAP3), K3(PAP3) are provided overall for each production schedule PAP1, PAP2, PAP3. The cost variables K1, K2, K3 respectively associated with a production schedule PAP1, PAP2, PAP3 are weighted with the weighting variables G1, G2, G3 in a weighting block 13 and a total cost variable KG is determined, for example according to the following rule:

KG=K1×G1+K2×G2+K3×G3

That production schedule PAPₒₚₜ whose total cost variable is lowest can be determined by comparing the total cost variables KG(PAP1), KG(PAP2), KG(PAP3) of the individual determined production schedules PAP1, PAP2, PAP3 in a comparison block 14. On the basis of the optimum production schedule PAPₒₚₜ, one or more other runs with changed process parameters and boundary conditions can now be started, the variation in the process parameters and the boundary conditions being oriented to the optimum production schedule PAPₒₚₜ determined. The process parameters and the boundary conditions are varied in an iteration block 15 on the basis of the optimum production schedule PAPₒₚₜ.

The above method can be iteratively carried out until an abort criterion is present. For example, the abort criterion can correspond to the reaching of a maximum number of repetitions of the process of determining the optimum production schedule or to the reaching of a predefined overall optimization criterion.

In summary, a task of the coordinator 2 is to control an involved optimizer 3 in such a manner that the overall solution corresponds to the specified goal. In this case, the specifications for the optimizers 3₁, 3₂, 3₃ are calculated according to the overall goal and are forwarded. On the basis of the partial optimization results obtained from the individual optimizers 3₁, 3₂, 3₃, this process is repeated until a significant improvement in the production schedule PAPₒₚₜ determined can no longer be expected. During optimization with respect to energy efficiency, the production speed and the use of energy stores in the production company can also be taken into account in the process as additional optimization degrees of freedom.

For example, the production speed can be taken into account in identical production machines which are used in a parallel manner by using only some of the production machines in the case of lower availability of energy and thus reducing the throughput or production speed. The number of several identical production processes to be used can be predefined in the form of a process parameter, for example during iteration.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Optimization system
2 Coordinator
3₁, 3₂, 3₃ Optimizer
4 User interface
5 Resource task network
6₁, 6₂, 6₃ Solver
11 Optimization block
12 Assessment block
13 Weighting block
14 Comparison block
15 Iteration block

What is claimed is:

1. Method for energy-efficient operation of a production plant in a production process of a manufacturing industry or a process industry, by causing a data processing unit to execute functions of:
creating and optimizing a first production schedule (PAP1) according to a predefined first cost function (KF1) and a predefined production process model (M), the first cost function (KF1) being designed to determine a first cost variable (K1) and taking into account efficient use of available energy as an optimization goal;
creating and optimizing one or more second production schedules (PAP2, PAP3) in parallel to the creating and optimizing of the first production schedule (PAP1) and according to a respective predefined second cost function (KF2, KF3) and the predefined production process model (M), the one or more second cost functions (KF2, KF3) being designed to determine one or more second cost variables (K2, K3) and taking into account as optimization goals one or more of the following production goals: production volume, plant protection, production safety or duration of maintenance intervals;
assessing the first (PAP1) and the one or more second (PAP2, PAP3) production schedules with the aid of the cost functions (KF2, KF3; KF1) with respect to other optimization goals, such that corresponding cost variables (K1(PAP1), K2(PAP1), K3(PAP1), K1(PAP2), K2(PAP2), K3(PAP2), K1(PAP3), K2(PAP3), K3(PAP3)) which indicate how the individual optimization goals have been achieved, are provided overall for each production schedule (PAP1, PAP2, PAP3);
weighing the cost variables (K1, K2, K3) respectively associated with one of the production schedules (PAP1, PAP2, PAP3) with weighting variables (G1, G2, G3);
determining a total cost variable (KG) as a sum of the weighted cost variables for each of the production schedules (PAP1, PAP2, PAP3);
determining that production schedule whose total cost variable is lowest as an optimum production schedule (PAPₒₚₜ); and
implementing the optimum production schedule in the production process for regulating and controlling production of the production plant.

2. Method according to claim 1, wherein during optimization with respect to energy efficiency, production speed and use of energy stores are taken into account as additional optimization degrees of freedom.

3. Method according to claim 1, the method being iteratively carried out by creating the first production schedule (PAP1) and the one or more second production schedules (PAP2) with at least one changed process parameter (PR) and/or at least one changed process boundary condition.

4. Method according to claim 3, the method being iteratively carried out until an abort criterion is present.

5. Method according to claim 4, wherein the abort criterion correspond to reaching a maximum number of repetitions of a process of determining the optimum production schedule (PAPₒₚₜ) or reaching a predefined overall optimization criterion.

6. Method according to claim 3, wherein the change in the process parameter (PR) and the process boundary condition are determined based on a previously determined optimum production schedule (PAPₒₚₜ).

7. Method according to claim 3, wherein the change in the process parameter relates to a number of parallel identical production processes or a power level of a production process which indicates power with which the production process is operated.

8. Method according to claim 3, wherein the change in the process boundary condition relates to a specification of a maximum and/or minimum storage quantity of an intermediate product and/or end product.

9. Apparatus for energy-efficient operation of a production plant in a production process of a manufacturing industry or a process industry, wherein data processing unit has an optimization system for determining an optimum production schedule (PAPₒₚₜ), the optimization system comprising:
a first optimizer for creating and optimizing a first production schedule (PAP1) according to a first cost function (KF1) and a predefined production process model (M), the first cost function (KF1) being designed to determine a first cost variable (K1) and taking into account efficient use of the available energy as an optimization goal;
a second optimizer for creating and optimizing one or more second production schedules in parallel with the creating and optimizing of the first production schedule (PAP1) and according to respective one or more second cost functions (KF2, KF3) and the predefined production process model (M), the one or more second cost functions (KF2, KF3) being designed to determine one or more second cost variables (K2, K3) and taking into account as other optimization goals one or more of the following production goals: production volume, plant protection, production safety or duration of maintenance intervals;
a respective assessment block for assessing the first (PAP1) and the one or more second (PAP2, PAP3) production schedules with aid of the cost functions (KF2, KF3; KF1) with respect to the other optimization goals, such that corresponding cost variables (K1(PAP1), K2(PAP1), K3(PAP1), K1(PAP2), K2(PAP2), K3(PAP2), K1(PAP3), K2(PAP3), K3(PAP3)) which indicate how the individual optimization goals have been achieved, are provided overall for each production schedule (PAP1, PAP2, PAP3);
a respective weighting block for weighing the cost variables (K1, K2, K3) respectively associated with one of the production schedules (PAP1, PAP2, PAP3) with weighting variables (G1, G2, G3);
a comparison block for determining a total cost variable (KG) as a sum of the weighted cost variables for each of the production schedules (PAP1, PAP2, PAP3), and for determining a production schedule whose total cost variable is lowest as an optimum production schedule (PAPₒₚₜ) to be implemented in the production process for regulating and controlling production of the production plant.

10. Computer program product containing a program code stored in non-transitory form which, when executed on a data processing unit, will cause the data processing unit to carry out a method according to claim 1.
